(19) United States
(12) Patent Application Publication
(10) Pub. No.: US 2012/0288842 A1
(43) Pub. Date: Nov. 15, 2012

(54) Personalized Course Management System

(76) Inventor: Thomas D. Cairns, Valencia, CA (US)

(21) Appl. No.: 13/295,011

(22) Filed: Nov. 11, 2011

Related U.S. Application Data
(60) Provisional application No. 61/412,718, filed on Nov. 11, 2010.

(51) Int. Cl. G09B 5/00

(52) U.S. Cl. 434/350

(57) ABSTRACT

Systems and methods for providing online courses are provided. A student seeking a higher education degree may enroll in courses, select, and control the timing and order of classes for a given program. Every course in a given program is available simultaneously. The courses are provided through a web-based instructional platform. Students can participate in one or more courses within one week of enrollment. A professor is assigned to the course. A professor can instruct more students and teach multiple courses simultaneously or in parallel, as opposed to the traditional classroom model. A student can personalize their enrollment and participate in the courses or progress through lessons of a course electronically through the web-based instructional platform via a software application on the smartphone, on their laptop and/or through an Internet browser at a particular website.

### SUMMARY OF THE INVENTION

Systems and methods for providing online courses for an accredited higher education degree are provided. A student seeking a higher education degree may design, customize, select or otherwise control the order of classes they must take to complete a given program. In other words, a student may self-direct their completion of the program requirements. The student also may have time management control of the actual timing of when they will enroll and take those classes. All the courses in the given program are provided simultaneously to a student for their selection. The courses themselves are provided to the student through a web-based instructional platform, whereby students can enroll and participate in one or more courses within one week of enrollment. The courses are provided to the student to take, with a live professor available as a resource to the student. By this model, a professor can instruct more students and teach multiple courses in simultaneously or in parallel, as opposed to the traditional model of in-person instruction in a classroom. A student can personalize their enrollment and participate in the courses or progress through lessons of a course electronically through the web-based instructional platform via a software application on their smartphone, on their laptop and/or through an Internet browser at a particular website.

### BRIEF DESCRIPTION OF THE DRAWINGS

FIG. 1 is a block diagram of an exemplary personalized course management system, according to carious embodiments of the technology.

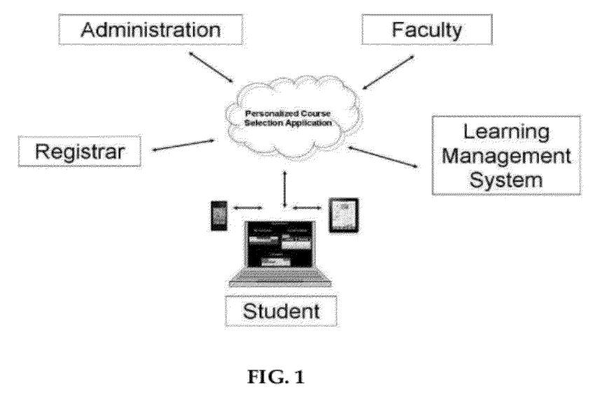

FIG. 2 is a block diagram of an exemplary dashboard provided by the exemplary personalized course management system of FIG. 1, according to carious embodiments of the technology.

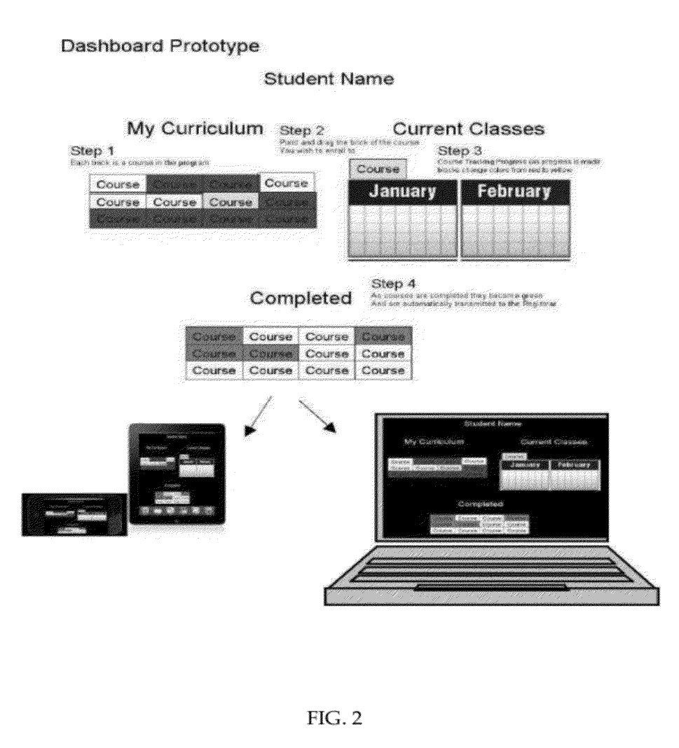

FIG. 3 is a diagram of an exemplary computing environment in which an exemplary personalized course management system may be practiced.

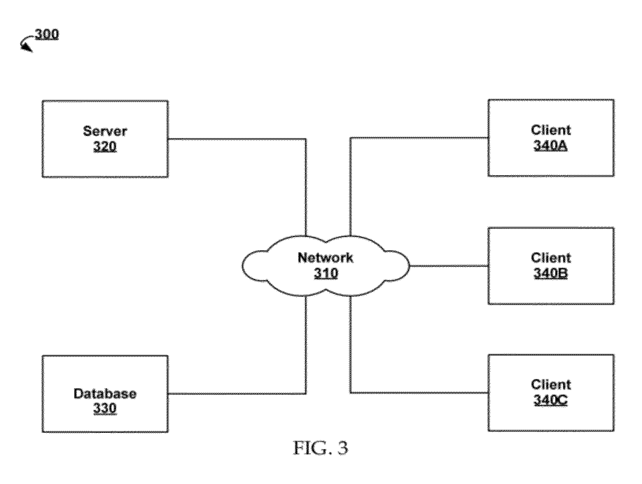

FIG. 4 depicts a computing device according to carious embodiments.

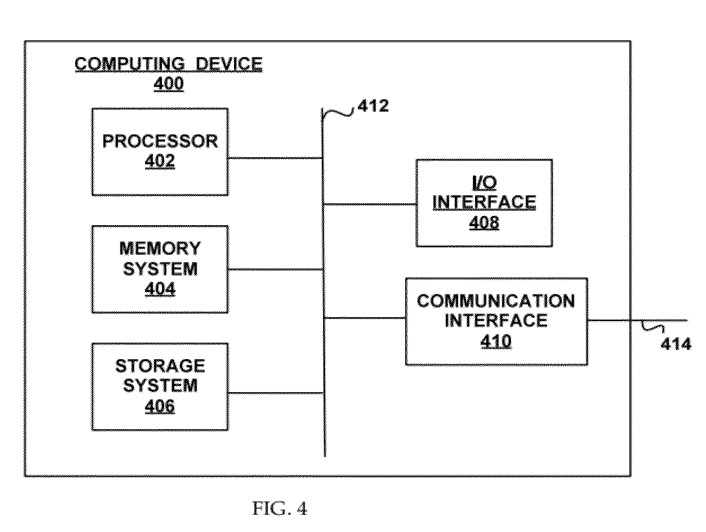

What is claimed is:

1. A method for providing personalized online course selections, comprising:
storing information relating to one or more selectable courses;
storing information relating to course materials associated with the one or more selectable courses;
receiving a request from a computing device via a web-based dashboard for information relating to the one or more selectable courses;
in response to the request for information relating to the one or more selectable courses, executing instructions stored in memory on the processor to simultaneously transmit information relating to one or more selectable courses to the computing device via the web-based dashboard;
receiving a course enrollment request from the computing device via the web-based dashboard, and
in response, executing instructions stored in memory on the processor to:
accept or deny the course enrollment request from the computing device;
provide course materials to the computing device if the course enrollment request is accepted; and
provide a notification to the computing device if the course enrollment request was denied.

2. A personalized online course selection system, comprising:
a communications interface for communicating one or more requests from the one or more computing devices to a web-based server via a web-based dashboard;
one or more databases coupled to the web-based server, the one or more databases for storing information relating to the one or more selectable courses and course materials associated with the one or more selectable courses;
the web-based server coupled to the communications interface and the one or more databases, the web-based server configured for:
providing a web-based dashboard to display on the one or more computing devices for selection and enrollment of the one or more selectable courses;
in response to a request for information relating to the one or more selectable courses, executing instructions stored in memory on a processor to simultaneously transmit information relating to one or more selectable courses to the one or more computing devices via the web-based dashboard;
in response to a course enrollment request for one or more selectable courses from the one or more computing devices via the web-based dashboard, executing instructions stored in memory on the processor to:
accept or deny the course enrollment request from the one or more computing devices;
transmit course materials relating to the one or more selectable courses from the one or more databases to the one or more computing devices, if the course enrollment request is accepted; and
provide a notification to the one or more computing devices, if the course enrollment request was denied.
